(19) United States
(12) Patent Application Publication
(10) Pub. No.: US 2001/0003409 A1
(43) Pub. Date: Jun. 14, 2001

(54) Display device with channels having a gradually decreasing depth

(76) Inventors: Matheus Godefridus Johannus Bel, Eindhoven (NL); Jacobus Johannes Van Glabbeek, Eindhoven (NL); Andre Reinoud De Wit, Eindhoven (NL)

Correspondence Address: Corporate Patent Counsel, U.S. Philips Corporation, 580 White Plains Road, Tarrytown, NY, 10591, US

(21) Appl. No.: 09/726,785

(22) Filed: Nov. 30, 2000

(30) Foreign Application Priority Data
Dec. 2, 1999 (EP) 99204088.1

(51) Int. Cl. H01J 61/28

(52) U.S. Cl. 313/231.31

(57) ABSTRACT

A display device (10), such as PALC or PDP, comprises a plate (36) with channels (20) in which electrodes (30, 31) are provided. The peripheral parts (50, 51) extend in a plane (III) between the bottom plane (I) though the bottoms of the channels and a plane (II) through the top of the channels. The channels comprise a sloping part (55) gradually sloping from the bottom plane (I) to the peripheral part plane (III).

The invention relates to a display device having a plate provided with longitudinal channels and a peripheral part adjacent to at least one side of the channels, in which channels electrodes are provided, which electrodes exit the channels on the peripheral part.

The invention also relates to a method of manufacturing a display device having a plate provided with longitudinal channels and a peripheral part adjacent to at least one side of the channels, in which channels electrodes are provided, which electrodes extend in the channels and exit the channels on the peripheral part.

Such devices are, for instance, PDP (Plasma Display Panels) and PALC (Plasma Activated Liquid Crystal) devices.

In PDP and PALC devices, the channels comprise gases. These gases can be locally made into plasma by generating of electric fields inside the channels. Electric fields are generated by applying voltages to electrodes in the channels. The generated plasma can be used to switch LCD elements (as in PALC devices) or excite phosphors (as in PDPs).

The channels are made in a plate. The plate has a peripheral part adjacent to at least one side of the channels. The electrodes exit the channels and extend on the peripheral part. Connections between the electrodes and driving means (or connections to driving means) are made at the peripheral part.

There is an ever more urgent need for high-quality, highly-reliable devices of the type described in the opening paragraph. The price of such devices is greatly dependent on the percentage of devices with an acceptable quality and reliability.

It is an object of the invention to increase the quality and the reliability of a device as described in the opening paragraph.

To this end, a device in accordance with the invention is characterized in that the peripheral part extends in a plane between a bottom plane through the bottom of the channels and a top plane through the top of the channels, and each channel comprises a sloping ramp sloping from the bottom plane to the plane and ending in the peripheral part.

The quality and reliability of the device is greatly dependent on the electric fields generated inside the channels. The fields inside the channels are generated by electric voltage differences between electrodes inside the channels. The driving means generate voltages but, as the inventors have realised, the actual voltages inside the channels are to a large degree dependent on the connections between the driving means and the electrodes inside the channels. The inventors have formed that particularly the transition region between the channels and the peripheral part (i.e. where the electrodes exit the channels and extend as far as the peripheral part) has a major influence. By having the peripheral region extending in a plane between a plane through the bottom of the channels and a second plane through the top of the channels, with each channel comprising a sloping ramp extending from the plane of the bottom of the channels to the plane of the peripheral part and ending in the peripheral part, steps in height between the channels and the peripheral part are prevented. The inventors have realized that such steps frequently cause problems.

The method in accordance with the invention is characterized in that, prior to or after providing the channels, the peripheral parts are provided in the plate at a depth between the bottom and the top of the channels provided or to be provided, whereafter the channels are provided by moving the grinding wheel(s) across the plate along a direction, the grinding operation being started at a position at some distance from an outer edge of the plate and being stopped before the grinding wheel reaches the opposite outer edge of the plate.

In this manner, the channels are provided at each end with a sloping ramp which smoothly blends with the peripheral part. The sloping ramps follow the contour of the grinding wheel.

Preferably, the electrodes are provided at the bottom of the channels and each channel comprises a central part having a first depth, flanked at at least one or preferably both sides by a second portion having a reduced depth, a third portion having a depth corresponding to the first portion, the bottoms of the first, second and third portions extending in the bottom plane, and a fourth portion comprising the sloping ramp, the second portion forming a groove in the plate, in which groove a sealing material is provided.

The second portions of the channels, having a reduced depth (in respect of the flanking first and second portions), form a groove. Said groove is provided with a sealing material (for instance glass frit). The channels are thereby sealed off from the environment. The electrodes in the channels are provided at the bottom of the channels. The risk of discontinuities in the electrodes is small.

These and other aspects of the invention are apparent from and will be elucidated with reference to the embodiments described hereinafter. Similar components in the Figures have identical reference numerals.

In the drawings:

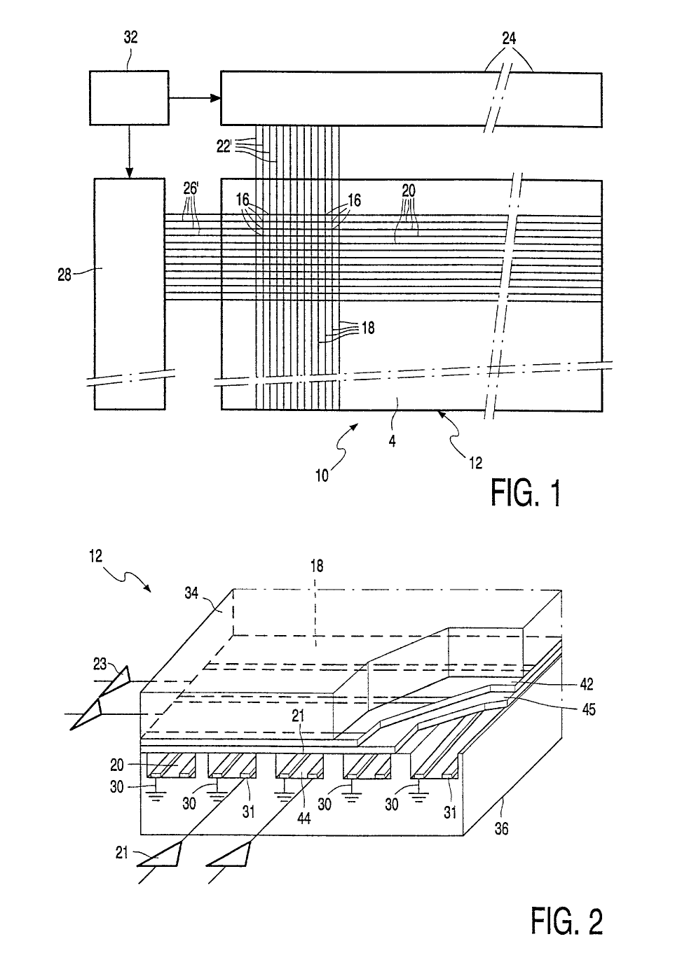

FIG. 1 is a schematic block diagram of a conventional flat panel display system;

FIG. 2 is a perspective view of a part of a conventional PALC display device.

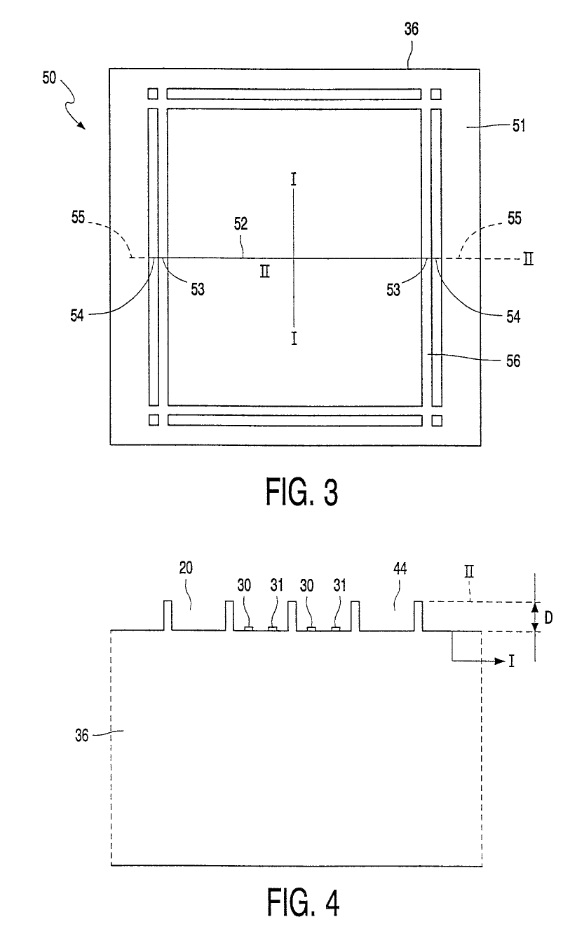

FIG. 3 is a view of a part of a display device in accordance with the invention.

FIG. 4 is a cross-sectional view through the part shown in FIG. 3.

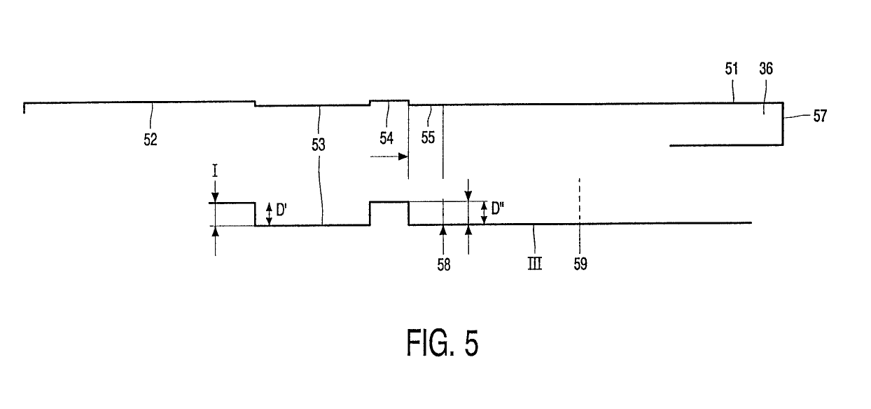

FIG. 5 is another cross-sectional view through the part shown in FIG. 3.

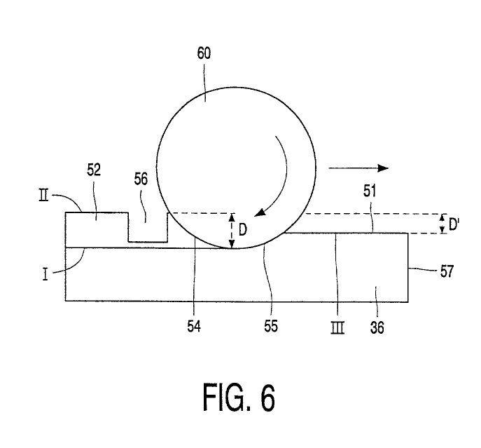

FIG. 6 illustrates the method in accordance with the invention.

The Figures are not drawn to scale and corresponding numerals in the Figures refer to the same or similar parts of a device.

FIG. 1 shows a flat panel display system 10, which represents a typical PALC display device and the operating electronic circuitry. With reference to FIG. 1, the flat panel display system comprises a display panel 12 having a display surface 14 that contains a pattern formed by a rectangular planar array of nominally identical data storage or display elements 16 mutually spaced apart by predetermined distances in the vertical and horizontal directions. Each display element 16 in the array represents the overlapping portions of thin narrow electrodes 18 arranged in vertical columns and elongate, narrow channels 20 arranged in horizontal rows (the electrodes 18 are hereinafter also referred to as ‘column electrodes’, the channels 20 performing the function of ‘row electrodes’). The display elements 16 in each row of channels 20 represents one line of data.

The widths of column electrodes 18 and channels 20 determine the dimensions of display elements 16, which are typically rectangular. Column electrodes 18 are deposited on a major surface of a first electrically non-conductive, optically transparent substrate 34, and the channel rows are made in a second transparent substrate 36 (FIG. 2). Skilled persons will appreciate that certain systems, such as reflective displays of either the direct view or projection type, would require only one substrate to be optically transparent. Column electrodes 18 receive data drive signals developed on parallel output electrodes 22′ by different ones of output amplifiers 23 (FIG. 2) of a data driver circuit 24, and channels 20 receive data strobe signals of the voltage pulse type developed on parallel output conductors 26′ by different ones of output amplifiers 21 (FIG. 2) of a data strobe or strobe means or strobe circuit 28. Each channel 20 includes a reference electrode 30 (FIG. 2) to which a first voltage, such as ground, common to each channel and data strobe 28 is applied.

To generate an image on the area of display surface 14, display system 10 employs a scan control circuit 32 that co-ordinates the functions of data driver 24 and data strobe 28 so that all columns of display elements 16 of display panel 12 are addressed row by row in a row-scan fashion. Display panel 12 may employ electro-optic materials of different types. For example, if it uses such a material that changes the polarization of incident light rays, display panel 12 is positioned between a pair of light polarizing filters, which cooperate with display panel 12 to change the luminance of light propagating through them. However, the use of a scattering liquid crystal cell as an electro-optical element would not require the use of polarizing filters. As LC materials are currently the most common examples, the description will refer to LC materials but it will be understood that the invention is not limited thereto.. A color filter (not shown) may be positioned within display panel 12 to develop multi-colored images of a controllable color intensity. For a projection display, color can also be achieved by using three separate monochrome panels 12, each of which controls one primary color.

FIG. 2 illustrates a PALC display panel using LC material. Only three of the column electrodes 18 are shown. The row electrodes 20 are formed by a plurality of parallel elongated sealed channels underlying (in FIG. 2) a layer 42 of the LC material. Each channel 20 is filled with an ionizable gas 44, closed off with a dielectric sheet 45 typically of glass, and contains, on an interior channel, first and second spaced elongated electrodes 30, 31 which extend through the full length of each channel in this example. The first electrode 30 is at a first potential (for instance, ground) and is commonly called the cathode. The second electrode 31 is called the anode, because it will supply and be supplied with a pulse voltage (strobe pulse) which is positive, relative to the potential on the cathode, and is sufficient to cause electrons to be emitted from the cathode 30 to ionize the gas in the channel(s). Each channel has, in turn, its gas ionized with a strobe pulse to form a plasma and a grounded line connection with a row of pixels in the LC layer above. When the strobe pulse has terminated, and after de-ionization has taken place, the next channel is ignited and turned on. Since each column electrode 18 crosses a whole column of pixels, only one plasma row connection at a time is allowed on so as to avoid cross-talk. The height of the strobe pulse voltage inside the channel will determine whether or not the plasma row is turned on. The height of the strobe pulse inside the channels is not just dependent on the voltages supplied by the output amplifiers 12, because losses or changes may occur between the output amplifiers and the electrodes within the channels. The clearest example of such a loss would be a discontinuity in an electrode (or the lead to the electrode) which would lead to malfunctioning. An accurate transmission and a reduction of possible losses of the strobe pulse between the supply means (in this example including the amplifiers 21) and the electrodes inside the channels is therefore an important factor for the reliability and quality of the display device. The inventors have realized that steps in height in the channels form a risk in this respect.

FIG. 3 shows a plate 36 provided with channels. The channels comprise a central first portion 52 flanked at both sides in this example by a second portion 53, a third portion 54 and a final portion 55. The final portions 55 are indicated by dotted lines and extend into the peripheral parts 50, 51. The final portions form sloping ramps 55.

FIG. 4 shows a cross-sectional taken on a line. The bottom of the channels 20 filled with ionizable gas extend in a bottom plane I, the tops extend in a top plane II, theses planes defining the depth D of the channels 20. Each channel 20 in plate 36 is provided with electrodes 30 and 31. The depth D is typically 0.15-0.25 mm, but is not limited thereto.

FIG. 5 shows the different parts of the channels. The central part 52 of the channels has a depth D and is flanked by a part 53 which has a depth D-D′ where D′<D. This can be realized, for instance, be means of a groove 56. The channel depth at this part 53 is therefore relatively small, for instance, only 0.01 mm. The electrodes 30 and 31 are, however, still situated in a channel. The third portion 54 basically has a shape and form which is equivalent to the central portion 52, be it that the longitudinal dimension (along the direction of the channels) is relatively small. The final portion of the channels 20 is formed by a sloping ramp part 55. Immediately beside the part 54, the depth of the channels is D-D″ where D″<D and preferably D′=D″. This depth decreases towards the outer edge 57 of peripheral part 51, becoming zero on the peripheral part, which is schematically indicated by line 59 in FIG. 5. The electrodes 30 and 31 are situated at the bottom of the channels and extend from the channels onto the peripheral part 51. On the peripheral part 51, leads can be attached to the electrodes to apply voltages to said electrodes during operation. Because of the sloping ramp 55, the electrodes 30, 31 can be provided to extend in the channels and on the peripheral part smoothly, i.e. without having to overcome a step in height. The groove 56 is filled with a sealing material thus sealing off the channels.

FIG. 6 illustrates the method in accordance with the invention. A peripheral part 51 and a groove 56 are made in plate 36. At these parts, the thickness of the plates is reduced by a value D′. Thereafter, grinding wheel 60 grinds channels to a depth of D where D>D′. The grinding moves in the directions indicated in the Figures. Movement is halted before the grinding wheel reaches edge 57 of plate 36. At the other end, the movement is not started at the edge of the plate but at some distance from said edge. FIG. 6 is not drawn to scale, the diameter of the grinding wheel is typically 8-16 cm. Grooves 56 and peripheral parts 51 are preferably made before the provision of the channels (i.e. before the grinding operation), but could be made afterwards.

It will be clear that the invention is not limited to the examples shown in the Figures and described above. Although for instance, the typical depth of the channels is given, this is not to be considered as limiting the invention. Although preferred, the provision of a groove 56 is not to be considered as limiting the invention in its broadest sense. The invention is furthermore illustrated by means of a PALC device, but could also be used for other flat panel display devices such as PDPs. Each channel could comprise one instead of two electrodes.

In summary, the invention can be described as relating to a display device with channels having a gradually decreasing depth at peripheral parts. The display device (10), such as PALC or PDP, comprises a plate (36) with channels (20) in which electrodes (30, 31) are provided. The peripheral parts (50, 51) extend in a plane (III) between the bottom plane (I) though the bottoms of the channels and a plane (II) through the top of the channels. The channels comprise a sloping part (55) gradually sloping from the bottom plane (I) to the peripheral part plane (III).

1. A display device (10) having a plate (36) provided with longitudinal channels (20) and a peripheral part (50, 51) adjacent to at least one side of the channels (20), in which channels electrodes (30, 31) are provided, which electrodes exit the channels (20) on the peripheral part (50, 51), characterized in that the peripheral part extends in a plane (III) between a bottom plane through the bottoms of the channels (I) and a top plane (II) through the top of the channels (20), and each channel comprises a sloping ramp (55) sloping from the bottom plane (I) to the plane (III) and ending in the peripheral part.

2. A display device as claimed in claim 1, characterized in that the electrodes (30, 31) are provided at the bottom of the channels (20) and each channel comprises a central part (52) having a first depth, flanked at at least one or preferably both sides by a second portion (53) having a reduced depth, a third portion (54) having a depth corresponding to the first portion (52), the bottoms of the first, second and third portions extending in the bottom plane (I), and a fourth portion comprising the sloping ramp (55), the second portion forming (53) a groove in the plate, in which groove a sealing material is provided.

3. A method of manufacturing a display device having a plate (36) provided with longitudinal channels (20) and a peripheral part (50, 51) adjacent to at least one side of the channels, in which channels electrodes (30,31) extending in the channels (20) and exiting the channels on the peripheral part are provided or are to be provided, characterized in that, prior to or after providing the channels, the peripheral parts are provided in the plate at a depth between the bottom and the top of the channels provided or to be provided, whereafter the channels are provided by moving a grinding wheel or grinding wheels across the plate along a direction, the grinding operation being started at a position at some distance from an outer edge (57) of the plate (36) and being stopped before the grinding wheel reaches the opposite outer edge of the plate.
